(19) United States
(12) Patent Application Publication
(10) Pub. No.: US 2002/0136903 A1
(43) Pub. Date: Sep. 26, 2002

(54) Theta solvents with functional siloxane adhesives improve adhesion to silicone rubber substrates

(75) Inventors: Robert N. Finsterwalder, New York, NY (US); James G. Russell, Fairport, NY (US); Sandra L. Schmitt, Williamson, NY (US)

Correspondence Address: Olif & Berridge PLC, P O Box 19928, Alexandria, VA, 22320, US

(73) Assignee: Xerox Corporation

(21) Appl. No.: 09/771,495

(22) Filed: Jan. 26, 2001

(51) Int. Cl. B32B 27/00

(52) U.S. Cl. 428/425.5; 492/53; 492/56

(57) ABSTRACT

This invention relates to a cross-linked polymer fuser member substrate that has been primed with a primer dissolved in a theta solvent. The substrate is contacted with the theta solvent in which the primer is dissolved. The solvent and the dissolved primer penetrate the cross-linked polymer network and cause it to swell. The solvent is removed such that the primer remains in the interstices and on the surface of the cross-linked polymer substrate.

### BACKGROUND OF THE INVENTION

In a typical electrostatographic reproducing or printing apparatus, a light image is recorded in the form of an electrostatic latent image upon a photosensitive member with an outermost release layer. The latent image is subsequently rendered visible by applying electroscopic thermoplastic resin particles that are commonly referred to as toner. The visible toner image is then in a loose powdered form and can be easily disturbed or destroyed. The fuser member can be heated to soften the toner so it can be released to the support. The toner image is usually fixed or fused upon a support such as a photosensitive member or a sheet of paper from the release layer.

In one typical fuser member used in an electrostatographic reproducing or printing apparatus, an organic polymeric substrate such as a cross-linked silicone rubber is coated with a release layer formed from a highly crosslinked organopolysiloxane on the fuser member surface. The release layer can be a high surface energy cross-linked fluoroelastomer outerlayer. Such release layers, while suitable to transfer an electrostatically recorded toner image to a sheet of paper, often display poor mechanical properties, including inadequate adhesion to the substrate due in part to the high surface energy and the heat applied to soften the toner. They are also susceptible to rapid wear and tearing from repeated contact with abrasive receiving sheets such as bond paper or uncoated laser print paper.

Thus, there is a need for fuser rolls and belts having substrate compositions that bind the release layer well and that are capable of producing multiple high quality toner images, including multicolor images. This need is well met by the toner fuser member and included priming agent composition of the present invention.

### SUMMARY OF THE INVENTION

The present invention relates to compositions useful as xerographic component surface primers. More specifically it relates to compositions for priming cross-linked polymer surfaces between layers useful in electrostatographic reproduction such as fuser members. The solutions of the present invention include theta solvents in which one or more suitable primers are dissolved. The theta solvent solution (with primer) can be applied to a cross-linked polymer such that the solution penetrates the polymer network causing the polymer to swell. The solvent is removed and the primer remains in the polymer after the solvent is removed.

The present invention further provides cross-linked polymer substrates wherein the surface characteristics of the substrate can be tailored to possess desired properties by the application of the primer of the invention. Also, the surfaces have superior chemical resistance, excellent thermal stability, and tear resistance.

Additionally, this invention provides multi-layer fuser members whose polymer layers are primed with the primer of the invention. These fuser members demonstrate the improved properties of the surfaces which have been treated with the primer of the invention. Such improved properties include increased adhesion between layers and superior chemical resistance, excellent thermal stability, and tear resistance.

The invention comprises a crosslinked polymer substrate on a fuser roll, where the polymer substrate has disposed thereon a primer interstitially bonded to the polymer substrate. The primer becomes interstitially bonded to the polymer substrate after a solution having the primer dissolved in a theta solvent is applied to the substrate such that the substrate swells and the solvent is removed. The substrate is preferably substantially free of the solvent. A preferred substrate is a crosslinked silicone rubber. The theta solvent is preferably hexane, heptane, toluene, or xylene. The primer is preferably an adhesive such as a functional siloxane adhesive. The primed substrate can be overcoated with a material such as a fluoroelastomer.

The invention further comprises a fuser roll having a first layer comprising a silicone rubber polymer and a second layer interstitially bonded thereto, wherein the second layer is applied by contacting said polymer with a solution comprising the primer dissolved in a theta solvent. The polymer is preferably crosslinked. The fuser roll can be overcoated with a third layer such as a fluoroelastomer. In one embodiment, the polymer requires a tensile pull force to separate the third layer from the polymer of about two times the force required to separate a similar polymer in which non-theta solvents were used.

The invention also includes a method for disposing a primer layer in a polymer layer. The method includes the steps of (1) contacting the polymer layer with a solution comprising a theta solvent in which a primer is dissolved; (2) allowing the polymer layer to swell such that the solution containing the primer is received in the polymer layer; and (3) removing the solvent to leave the primer disposed in the polymer layer. The solvent is preferably removed by evaporation. Heat, forced air or low pressure can be used to increase the rate of evaporation.

### Detailed Description

Theta Solvent-Primer Solutions and Their Applications

The general mechanism by which the invention is believed to operate is that a theta solvent swells a polymer substrate such that the theta solvent and a primer dissolved therein are absorbed into the polymer network. After the polymer network absorbs the theta solvent and dissolved primer, the solvent is removed (in the case of the examples, by evaporation) such that the substrate swelling is reduced. The primer, commonly an adhesive, remains interstitially bound in the polymer network. The interstitial binding of the adhesive to the substrate increases the binding strength of the substrate to the overcoat.

A theta solvent is a solvent that is capable of swelling a polymer network, such as a silicone polymer network, without dissolving or breaking the covalent polymer bonds. A preferred theta solvent can dissolve a primer such as an adhesive or another material to be included in a cross-linked polymer. This general definition of a theta solvent is usually satisfied by any liquid which could be described as a “good” solvent for the polymer. Some preferred theta solvents include toluene, hexane, heptane, and xylene.

Primer refers to a material that imparts a particular property to a substrate, usually to the substrate surface in preparation for receiving an overcoat layer on the substrate. In one embodiment of the invention, a preferred primer is an adhesive. In another embodiment, a primer is an insulator or a conductor of heat.

An adhesive primer that has been interstitially bound to a substrate adheres exceptionally well to a subsequent layer such as an outer layer when compared to the same adhesive that has not been interstitially bound using the method of the invention. In certain instances, the tensile pull force required to separate an outer layer from a primed polymer substrate layer is more than doubled by the interstitially bound adhesive. The increased adhesive performance results in longer fuser member life because the outer layer is less susceptible to tearing and other sources of wear.

An adhesive is a composition which binds two materials solidly together. Adhesive bonding involves the wetting of an organic material to surfaces (adherents) between two or more similar or dissimilar materials to join them chemically or physically. Physically bonded adhesives include compositions (such as a latex) which bond by the evaporation of a solvent and are generally weaker adhesives than those that are chemically bonded. Adhesives preferably comprise a range of thermosetting and thermoplastic materials and are cured (i.e. chemically bonded) to achieve maximum performance. Suitable adhesives include, but should not be limited to, resins and elastomers. Preferred adhesives include functional siloxane adhesives.

A polymer network or cross-linked polymer refers to a composition that has multiple cross-links connecting many polymer chains. A cross-link is a small region in a macromolecule from which at least four chains emanate. A polymer network contains interstitial spaces between the polymer chains that are joined at the cross-links. A preferred polymer substrate of the present invention includes a polymer that swells in the presence of a theta solvent by absorbing the solvent into the interstitial spaces without breaking the cross-linkages.

The term tensile pull force refers to the force required to pull apart an overcoat from a substrate. Suitable means for measuring pull force include, but are not limited to, using an INSTRON® tensile tester using the method as follows. A three inch long, half inch wide strip of a non stretch material, such as reinforced MYLAR®, is bonded to the over coated substrate. Slits are made along the edge of the pull strip so that the test area is restricted to the edges of the strip. The substrate is clamped in such a way as to be normal (that is 900°) to the pull force applied by the INSTRON® tester. The free end of the strip is clamped in the INSTRON® jaws and the pull force is applied. The force to initiate tear of the overcoat off the substrate is defined as the adhesive force of tear. The preferred tear force is cohesive which is defined as the tearing of or failure within the substrate, where as the separation at the test strip substrate interface is defined as adhesive tear. A suitable range for tensile pull force of the present invention ranges from about 1.5 pounds per inch to about 2 pounds per inch. A preferred range for tensile pull force is about 2.5 to about 3 pounds per inch. It is preferred that a tensile pull force of the present invention be greater than the tensile pull force of a substrate and overcoat in which a theta solvent is not used to apply an adhesive to the substrate.

In the invention, a primer, preferably an adhesive primer, is dissolved in a theta solvent. The selection of a particular theta solvent, a primer, and the ratio between the two would be guided by the properties sought in the final fuser roll and the compatibility between the solvent and primer. The ratio of primer to solvent can range from about 0.5% to about 10% by weight. A preferred ratio is about 5% primer when using a functional siloxane in toluene to be applied to a silicone rubber substrate.

Any of a number of methods can be used to prepare the solution such as mixing by hand or machine. The solution can be prepared in large batches if the primer dissolves well in the solvent. If the primer will precipitate from solution, the solution is best prepared with sufficient time to apply to a substrate before precipitation in an amount that would affect the introduction of the primer into the interstices of the substrate.

The solution can be applied to a polymer substrate in a variety of ways. The polymer substrate can be dipped into or flow coated or sprayed with the solution. It is preferred that the solution be applied such that the polymer substrate swells by the penetration of the solution into the interstices of the polymer network. This allows the primer in the solution to be incorporated into the polymer network after the solvent is removed.

The solvent can be removed from the polymer substrate by evaporation. In some instances, it may be preferable to apply heat, forced air, forced hot air or low pressure vacuum to increase the rate of evaporation. If heat is applied, the temperature is preferably lower than the flash point of the theta solvent and the melting point of the polymer. If the temperature exceeds the solvent's flashpoint the solvent will combust, scorch the polymer substrate and affect the performance of the adhesive. The polymer substrate can become deformed and uneven if the temperature goes above its melting point.

After the solvent has been removed, a subsequent intermediate layer or an outer layer can be applied to the primed polymer substrate. Suitable outer layers are described below. Preferred outer layers include fluoroelastomers that do not require a release oil. Outer layers applied to a theta solvent primed polymer substrate preferably adhere more strongly than outer layers applied to polymer substrates primed without using a theta solvent.

Fuser Members

The terms fuser system members or fuser members, include donor rolls, belts, films, sheets, and the like; pressure rolls, belts, films, sheets, and the like; fuser rolls, belts, films, sheets and the like; toner transfer system members including toner transfer components such as rollers, belts, films, sheets and the like; and biasable system members including biasable components such as bias transfer or bias charging rolls, belts, films, sheets and the like. Preferred fuser members are fuser rolls suitable for electrographic printing or reproduction.

A variety of substrates may be selected for the fliser member. The fuser member substrate may be a roll, belt, flat surface, sheet, film, or other shape used in the fixing of thermoplastic toner images to a supporting substrate. It may take the form of a fuser member, a pressure member or a release agent donor member, preferably in the form of a cylindrical roll. Typically, the fuser member is made of a hollow cylindrical metal core, such as copper, aluminum, stainless steel, or certain plastic materials chosen to maintain rigidity, structural integrity, as well as being capable of having a polymeric material coated thereon and adhered firmly thereto. It is preferred that the supporting substrate is a cylindrical metal roller. In one embodiment, the core, which may be an aluminum or steel cylinder, is degreased with a solvent and cleaned with an abrasive cleaner prior to being primed with a primer, such as Dow Corning 1200, which may be sprayed, brushed or dipped, followed by air drying under ambient conditions for thirty minutes and then baked at 150° C. for 30 minutes.

In some embodiments, a fuser member substrate is coated with an intermediate layer, an adhesive and an outer layer. Other layers may be incorporated between the outer polymer layer and the intermediate silicone rubber layer, or between the substrate and the intermediate silicone rubber layer.

Intermediate Substrate Layer

An intermediate substrate layer preferably comprises a silicone rubber of a thickness so as to form a conformable layer. Suitable silicone rubbers include room temperature vulcanization (RTV) silicone rubbers, high temperature vulcanization (HTV) silicone rubbers and low temperature vulcanization (LTV) silicone rubbers. These rubbers are known and readily available commercially such as SILASTIC® 735 black RTV and SILASTIC® 732 RTV, both from Dow Corning; and 106 RTV Silicone Rubber and 90 RTV Silicone Rubber, both from General Electric. Other suitable silicone materials include the silanes, siloxanes (preferably polydimethylsiloxanes) such as, fluorosilicones, dimethylsilicones, liquid silicone rubbers such as vinyl crosslinked heat curable rubbers or silanol room temperature crosslinked materials, and the like.

Outer Layers

Examples of outer fusing layers of the fuser member herein include polymers such as fluoropolymers. Particularly useful fluoropolymer coatings for the present invention include TEFLON®—like materials such as polytetrafluoroethylene (PTFE), fluorinated ethylenepropylene copolymer (FEP), perfluorovinylalkylether tetrafluoroethylene copolymer (PFA TEFLON®), polyethersulfone, copolymers and terpolymers thereof, and the like. Also preferred are fluoroelastomers such as those described in detail in U.S. Pat. Nos. 5,166,031; 5,281,506; 5,366,772; 5,370,931; 4,257,699; 5,017,432; 5,061,965; 4,891,407; 5,066,683; and 5,157,058.

A fluoroelastomer is an elastomeric fluorinated polymer. A wide variety of fluoroelastomers are suitable for use in the present invention. Fluoroelastomers, particularly from the class of copolymers, terpolymers, and tetrapolymers of vinylidenefluoride, hexafluoropropylene and tetrafluoroethylene and a possible cure site monomer, are known commercially under various designations as VITON A®, VITON E®, VITON E60C®, VITON E430®, VITON 910®, VITON GH®, VITON GF®, VITON E45® and VITON B50®. The VITON® designation is a Trademark of E. I. DuPont de Nemours, Inc. Other commercially available materials include FLUOREL 2170®, FLUOREL 2174®, FLUOREL 2176®, FLUOREL 2177® and FLUOREL LVS 76®. FLUOREL® is a Trademark of 3M Company. Additional commercially available materials include AFLAS® a poly(propylene-tetrafluoroethylene) and FLUOREL II®(LII900) a poly(propylene-tetrafluoroethylenevinylidenefluoride) both also available from 3M Company, as well as the TECNOFLONS® identified as FOR-60KIR®, FOR-LHF®, NM®, FOR-THF®, FOR-TFS®, TH®, TN505® available from Montedison Specialty Chemical Company. In another preferred embodiment, the fluoroelastomer is one having a relatively low quantity of vinylidenefluoride, such as in VITON G, available from E. I. DuPont de Nemours, Inc. The VITON GF® has 35 weight percent of vinylidenefluoride, 34 weight percent of hexafluoropropylene and 29 weight percent of tetrafluoroethylene with 2 weight percent cure site monomer. The cure site monomer can be those available from DuPont such as 4-bromoperfluorobutene-1, 1, 1-dihydro-4-bromoperfluorobutene-1, 3-bromoperfluoropropene-1, 1,1-dihydro-3-bromoperfluoropropene-1, or any other suitable, known, commercially available cure site monomer.

Release Oils, Fillers and Surfactants

Polymeric fluid release agents can be used in combination with the polymer outer layer to form a layer of fluid release agent which results in an interfacial barrier at the surface of the fuser member while leaving a non-reacted low surface energy release fluid as an outer release film. Suitable release agents include both functional and non-functional fluid release agents.

Preferred are the non-functional release agents including known polydimethyl siloxane release agents. However, functional release agents such as amino-functional, mercapto functional, hydride functional and others, can be used. Specific examples of suitable amino functional release agents include T-Type amino functional silicone release agents disclosed in U.S. Pat. No. 5,516,361; monoamino functional silicone release agents described in U.S. Pat. No. 5,531,813; and the amino functional siloxane release agents disclosed in U.S. Pat. No. 5,512,409, the disclosures each of which are incorporated herein in their entirety. Examples of mercapto functional release agents include those disclosed in U.S. Pat. Nos. 4,029,827; 4,029,827; and 5,395,725. Examples of hydride functional oils include U.S. Pat. No. 5,401,570. Other functional release agents include those described in U.S. Pat. Nos. 4,101,686; 4,146,659; and 4,185,140.

Other release agents include those described in U.S. Pat. Nos. 4,515,884 and 5,493,376. However, it is preferred to use a non-functional release agent with the present fuser configuration. However, in a preferred embodiment, little or no fuser release agent is necessary due to the increased release and decreased surface energy provided by the fuser members disclosed herein.

If a functional fuser oil is used in an embodiment of the invention, for example to improve the release of toner or lower surface energy, conductive fillers may be dispersed in the outer fusing layer of the fuser member. Preferred fillers are capable of interacting with any functional groups of the release agent to form a thermally stable film which releases the thermoplastic resin toner and prevents the toner from contacting the filler surface material itself. This bonding enables a reduction in the amount of oil needed to promote release. Further, preferred fillers promote bonding with the oil, without causing problems of scumming or gelling. In addition, it is preferred that the fillers be substantially non-reactive with the outer polymer material so that no adverse reaction occurs between the polymer material and the filler which would hinder curing or otherwise negatively affect the strength properties of the outer surface material.

However, in a preferred embodiment, there is no conductive filler present in the outer layer of the fuser member. In addition, it is preferred to use either a non-functional release agent with a TEFLON®—like material with no added conductive fillers, or alternatively, to use no fuser oil and no conductive fillers in the outer polymeric layer.

Other adjuvants and fillers may be incorporated in the layers in accordance with the present invention provided that they do not significantly adversely affect the integrity of the polymer material. Such fillers normally encountered in the compounding of elastomers include coloring agents, reinforcing fillers, and processing aids. Oxides such as magnesium oxide and hydroxides such as calcium hydroxide are suitable for use in curing many fluoropolymers.

In a preferred embodiment of the invention, the surface energy of the outer polymeric layer may be reduced by adding a surfactant to the outer surface. Further, addition of a surfactant reduces pin hole defects by actually filling in or smoothing out any defects. The surfactant provides a uniform oil film that aids in uniform gloss and prevents offsetting due to microporosity.

Examples of surfactants include anionic, cationic, zwitterionic and amphoteric surfactants. Preferred are cationic surfactants such as amine compounds such as alkyl amines, and ammonium compounds such as ammonium halides. Specific examples of useful surfactants include alkyl sulfates (such as STEPANOL® SLS surfactant, a product of Stepan Company); cationics including alkyl triammonium halides (such as CTAB® surfactant, a product of VWR Scientific Inc.), polyoxyethylene cocoamine (such as MAZEEN® surfactant, a product of PPG Industries), primary alkyl amines (such as ARMEEN® surfactant, a product of Akzo Chemical Co., and others such as ADOGEN® 180-C10 ether amine, ADOGEN® 183-C13 ether amine, AROSURF® MG-70A3 isodecyl ether amine acetate, and AROSURF(® MG-70A5), dicoco dimethyl ammonium halide (such as JET QUAT® surfactant, a product of Jetco Chemical Inc.), di-isodecyl dimethyl ammonium halides (such as AMMONYX® K9 surfactant, a product of Stepan Company), diaminoethyl stearate (such as CERASYNT® 303); amphoteric surfactants such as sodium cocoamphotacetate from Mcintyre Group, ADOGEN® 425-50% (a 50% aqueous solution of a trimethyl soya quaternary ammonium chloride surfactant), DERIPHAT® 154-L, a disodium N-tallow beta-iminodipropionate available from Henkel; any of the amine amphoterics from Akzo Chemicals, and anionic surfactants such as potassium sulphates, benzene sulphonates, ether sulphonates, sodium coconut oil fatty monoglyceride sulphates and sulphonates, the reaction products of fatty acids, and olefin sulphonates. Other suitable surfactants include fish oil such as KELLOX®-3-Z from Kellog Company, oleylamine from ARMEEN® O, or N-alkyl-1,3-diaminopropane dioleate, available as DUOMEEN® TDO, products of Akzo Chemie America.

A suitable surfactant can be coated on the outer polymeric layer by known methods such as embedding in the polymeric layer or adding to fuser oil, preferably 5-10 ml/liter.

Methods for Applying Polymer Layers

The polymer layers of the present invention can be coated on the fuser member substrate by any means including normal spraying, dipping and tumble spraying techniques. A flow coating apparatus as described in U.S Pat. No. 5,871,832, entitled “Leveling blade for flow coating process for manufacture of polymeric printer roll and belt components,” can also be used to flow coat fuser rolls. It is preferred that the polymers be diluted with a solvent, and particularly an environmentally friendly solvent, prior to application to the fuser substrate.

Toners

The fuser members are useful in combination with many toners, including black and white toner or color toner. Color toners include those listed in U.S. Pat. Nos. 5,620,820; 5,719,002; and 5,723,245.

### EXAMPLES

The breadth of the invention is understood from the complete description of the invention including the claims. The following examples are intended to show embodiments of the invention without limiting the claims that follow. Additionally, all cited references, patents and patent publications mentioned throughout this description are hereby incorporated by reference in their entirety.

A method for determining effective theta solvents for a particular set of materials involves immersing strips of a sample of a solid test elastomer in a theta solvent. For example, an aluminum oxide and iron (III) oxide filled, cured silicone rubber was used in the following examples numbered 1 to 5. The sample was immersed at room temperature for a sufficient period that the solvent swelling reached equilibrium, i.e. the sample did not further change volume. After sufficient immersion, the sample was measured in length, width and thickness. The change in dimension was compared to the original pre-swollen dimensions to give an increase in volume due to solvent swell. The solvent was selected on the basis of the largest increase in dimensions. The range of swelling from the lowest to the highest was isopropyl alcohol, toluene and heptane.

Test samples for examples numbered 1 to 5 below were prepared by making solutions of the primer, A-1100, in the three above solvents. The method employed was the flow coating apparatus described in U.S. Pat. No. 5,871,832 entitled “Leveling blade for flow coating process for manufacture of polymeric printer roll and belt components”. The different solvents and a primer designated A1100 were coated on polymeric silicone rubber fuser rolls. The flow rate was controlled to deposit solvent diluted adhesive at a nominal one to two microns in thickness. The coated substrate was allowed to dwell at room temperature for ten to sixty minutes with 15 minutes being preferred at a relative humidity of 20 to 80% with 55% being preferred. At the completion of the dwell, the rolls were coated with a fluorelastomer coating and dwelled and additional twenty-four hours before oven curing. The preferred oven curing cycle is four hours at 130° F., two hours at 200° F., two hours at 300° F., two hours at 350° F., two hours at 400° F. and six hours at 450° F. Testing and evaluation of the tensile strength was done with the INSTRON® procedure detailed above.

More than one hundred fuser rolls have been made with the preferred solvent primer system of A-1100 with toluene and have experienced no failures up to approximately 500,000 prints which can be attributed to the failure of the adhesive to substrate interface. Fuser rolls using the A-1100 primer without a theta solvent routinely experience failures at less than 100,000 prints.

### Example 1

### Isopropanol and 5% A1100

In a first example, a standard solution with isopropanol and 5% A1100, an average adhesive with usually low color, low peel force and no rubber tear was applied to a silicone rubber substrate. The resulting substrate showed low color which indicates poor incorporation of adhesive in the substrate.

### Example 2

### Toluene

In a second example, toluene (a theta solvent) alone was applied to a silicone rubber substrate. The substrate was overcoated with a fluoroelastomer. A tensile pull force was applied to separate the overcoat from the substrate. The results showed toluene in the absence of the primer adhesive did not increase adhesion of the silicone rubber substrate to a fluoroelastomer overcoat.

### Example 3

### Toluene and 5% A1100

In a third example, toluene and 5% A1100 were applied to a silicone rubber substrate. The substrate was overcoated with a fluoroelastomer. A tensile pull force was applied to separate the overcoat from the substrate. The results showed an increase in color, peel force, and rubber tear.

### Examples 4 and 5

### N-Heptane (Ex. 4) and N-Heptane plus 5% A1100

In fourth and fifth examples, an n-heptane base, was substituted for toluene as used in the second and third examples. The substrate was then overcoated with a fluoroelastomer. A tensile pull force was applied to separate the overcoat from the substrate. The n-heptance alone (fourth example) showed results similar to toluene without primer.

On the other hand, the n-heptane base with adhesive primer (5% A1100) (fifth example) showed an increase in color, peel force, and rubber tear. The rubber tear appeared to be slightly less than that observed with toluene plus adhesive primer.

The results of the preceding examples are shown in Table 1. Based on these results, it is understood that a theta solvent increases the ability of the adhesive dissolved therein to better bind the substrate to the overcoat as compared to when a non-theta solvent is used.

TABLE 1
Results show theta solvent increases presence of adhesive in polymer

| | | | Color on | | |
|---|---|---|---|---|---|
| Example | Solvent | Adhesive | Peel Strip | Peel Force | Rubber Tear |
| 1 | Isopropyl | 5% | Low | Low | Low |
| | alcohol | A1100 | | | |
| 2 | Toluene | None | Low | Low | Low |
| 3 | Toluene | 5% | High | High | High |
| | | A-1100 | | | |
| 4 | n-Heptane | None | Low | Low | Low |
| 5 | n-Heptane | 5% | High | High | Medium |
| | | A-1100 | | | |

While the invention has been described in detail with reference to specific and preferred embodiments, it will be appreciated that various modifications and variations will be apparent to the artisan. All such modifications and embodiments as may occur to one skilled in the art are intended to be within the scope of the appended claims.

The claimed invention is:

1. A crosslinked polymer substrate for a fuser roll, said polymer substrate having disposed thereon a primer interstitially bonded to said substrate, wherein said primer is interstitially bonded after a solution having the primer dissolved in a theta solvent was applied to the substrate.

2. The substrate of claim 1, wherein the substrate is substantially free of the solvent.

3. The substrate of claim 2, wherein the substrate is a crosslinked silicone rubber.

4. The substrate of claim 3, wherein the solvent is selected from the group consisting of hexane, heptane, toluene, and xylene.

5. The substrate of claim 4, wherein the primer is a functional siloxane adhesive.

6. The substrate of claim 1, wherein the primer is overcoated with a material.

7. The substrate of claim 6, wherein the material is a fluoroelastomer.

8. A fuser roll having a first layer comprising a silicone rubber polymer and a second layer interstitially bonded thereto, wherein the second layer is applied by contacting said polymer with a solution comprising the primer dissolved in a theta solvent.

9. The fuser roll of claim 8, wherein the polymer is crosslinked.

10. The fuser roll of claim 8, wherein the primer is a functional siloxane adhesive.

11. The fuser roll of claim 10, wherein said second layer is overcoated with a third layer.

12. The fuser roll of claim 11, wherein said third layer is a fluoroelastomer.

13. The fuser roll of claim 12, wherein the polymer requires a tensile pull force to separate the material from the polymer of about two times the force required to separate a similar polymer in which non-theta solvents were used from a similar material.

14. A method for disposing a primer layer in a polymer layer, said method comprising:
contacting the polymer layer with a solution comprising a theta solvent in which a primer is dissolved;
allowing the polymer layer to swell such that the solution containing the primer is received in the polymer layer; and
removing the solvent to leave the primer disposed in the polymer layer.

15. The method of claim 14, wherein the solvent is removed by evaporation.

16. The method of claim 15, wherein the polymer is a crosslinked silicone rubber.

17. The method of claim 16, wherein the solvent is selected from the group consisting of hexane, heptane, toluene, and xylene.

18. The method of claim 17, wherein the primer is a functional siloxane adhesive.

19. The method of claim 18, wherein the polymer is a layer on a fuser roll.

20. The method of claim 19, wherein an overcoat is applied to the layer.

21. The method of claim 20, wherein the overcoat is a fluoroelastomer.
